(19) United States
(12) Patent Application Publication
(10) Pub. No.: US 2025/0058668 A1
(43) Pub. Date: Feb. 20, 2025

(54) CHARGING CONTROL METHOD, CONTROL DEVICE, CHARGING PILE, AND CHARGING SYSTEM

(71) Applicant: Autel Digital Power Co., Ltd., Shenzhen (CN)

(72) Inventor: Yulong MO, Shenzhen (CN)

(73) Assignee: Autel Digital Power Co., Ltd., Shenzhen (CN)

(21) Appl. No.: 18/935,415

(22) Filed: Nov. 1, 2024

Related U.S. Application Data
(63) Continuation of application No. PCT/CN2023/078501, filed on Feb. 27, 2023.

(30) Foreign Application Priority Data
May 6, 2022 (CN) 202210487830.6

(51) Int. Cl. B60L 53/62; B60L 53/66

(52) U.S. Cl. CPC B60L 53/62; B60L 53/66

(57) ABSTRACT

Provided is a charging control method, applied to a charging pile. The method includes: acquiring a charging current, a terminal voltage of charging loop, and a voltage of one or more batteries by means of a battery management system when the charging pile charges the one or more batteries; obtaining a connection cable resistance value and an internal resistance of the one or more batteries according to the charging current, the terminal voltage of charging loop, and the voltage of one or more batteries; determining, according to the connection cable resistance value and the internal resistance of the one or more batteries, whether early warning is needed; and when early warning is needed, reducing a duty cycle of a first signal, and outputting the first signal to a charging controller. The charging pile can perform information interaction with a battery pack, to perform safe charging control according to charging parameters.

### CROSS-REFERENCE TO RELATED APPLICATIONS

This application is a continuation application of International Patent Application No. PCT/CN2023/078501 filed on Feb. 27, 2023, which claims priority to Chinese Patent Application No. 202210487830.6 filed on May 6, 2022, the entire disclosures of both of which are incorporated herein by reference for all purposes.

### TECHNICAL FIELD

The present disclosure relates to the technical field of charging control, and in particular to a charging control method, a control device, a charging pile, and a charging system.

### BACKGROUND

At present, there is no information interaction between the existing charging pile and the electric vehicle, and the charging pile does not perform safe charging control according to the battery pack state of the electric vehicle, resulting in a high safety risk during charging.

### SUMMARY

Embodiments of the present disclosure provide a charging control method, a control device, a charging pile, and a charging system, where when the method is applied to the charging pile, the charging pile can perform information interaction with a battery pack, so that the charging pile performs safe charging control according to charging parameters, thereby reducing the charging safety risk.

In a first aspect, embodiments of the present disclosure provide a charging control method, applied to a charging pile, the method includes: acquiring a charging current, a terminal voltage of charging loop, and a voltage of one or more batteries by means of a battery management system when a charging pile charges each battery, wherein the charging pile is configured to connect an electric equipment, the electric equipment comprising a battery pack and a charging controller, the battery pack comprising the battery management system and n batteries, the battery management system being connected to the one or more batteries and communicatively connected to the charging pile, and the batteries being connected in series, wherein n≥2, and n is an integer; obtaining a connection cable resistance value and an internal resistance of the one or more batteries according to the charging current, the terminal voltage of charging loop, and the voltage of the one or more batteries; determining, according to the connection cable resistance value and the internal resistance of the one or more batteries, whether early warning is needed; and in response to determining that early warning is needed, reducing a duty cycle of a first signal, and outputting the first signal to a charging controller, such that the charging controller controls the charging current according to the first signal.

In a second aspect, some embodiments of the present disclosure provide a control device including: at least one processor, and a memory communicatively connected to the at least one processor; where the memory stores instructions executable by the at least one processor, the instructions being executed by the at least one processor to enable the at least one processor to perform the method of the first aspect above.

In a third aspect, some embodiments of the present disclosure provide a charging pile, including a power switch, a charging interface, and a control device as described in the second aspect above; a first end of the power switch is used for connecting to an alternating current power supply, a second end of the power switch is used for connecting to an input end of the charging interface, a third end of the power switch is also connected to the control device, and an output end of the charging interface is used for connecting to a battery pack.

In a fourth aspect, some embodiments of the present disclosure provide a charging system, including electric equipment, and the charging pile as described in the third aspect above; the electric equipment includes a battery pack and a charging controller, the battery pack includes a battery management system and n batteries, the batteries are successively connected in series with an output end of the charging interface, the battery management system is respectively connected to one or more batteries, the battery management system and the charging controller are respectively connected in communication with the control device, the charging controller is connected to the one or more batteries, and the charging controller is used for controlling the charging current of the one or more batteries, where n≥2, and n is an integer.

In a fifth aspect, embodiments of the present disclosure provide a computer-readable storage medium storing computer-executable instructions for causing a computer to perform the method of the first aspect above.

In a sixth aspect, some embodiments of the present disclosure provide a computer program product including a computer program stored on a computer-readable storage medium, the computer program including program instructions which, when executed by a computer, cause the computer to perform the method of the first aspect above.

### BRIEF DESCRIPTION OF DRAWINGS

One or more embodiments are illustrated by way of example in the accompanying drawings which correspond to and are not to be construed as limiting the embodiments, in which elements/modules and steps having the same reference numeral designations represent like elements/modules and steps throughout, and in which the drawings are not to be construed as limiting in scale unless otherwise specified.

FIG. 1 is a block diagram showing a charging system according to an embodiment of the present disclosure;

FIG. 2 is a schematic structural diagram showing a control device according to an embodiment of the present disclosure;

FIG. 3 is a schematic flow chart showing a charging control method according to an embodiment of the present disclosure; and

FIG. 4 is a partial schematic flow chart showing a charging control method according to an embodiment of the present disclosure.

### DETAILED DESCRIPTION

The present disclosure is described in detail below in conjunction with embodiments. The following embodiments will aid a person skilled in the art in further understanding the present disclosure, but do not limit the present disclosure in any way. It should be noted that several variations and modifications can be made by a person skilled in the art without departing from the concept of the present disclosure. These are all within the scope of protection of the present disclosure.

To facilitate an understanding of the present disclosure, a more detailed description of the present disclosure will be rendered by reference to specific embodiments thereof which are illustrated in the accompanying drawings. Unless defined otherwise, all technical and scientific terms used in the description have the same meaning as commonly understood by a person skilled in the art to which the present disclosure belongs. The terminology used in the description of the present disclosure herein is for the purpose of describing embodiments only and is not intended to be limiting of the present disclosure. As used herein, the term “and/or” includes any and all combinations of one or more of the associated listed items.

It should be noted that, if not in conflict, the various features of the embodiments of the present disclosure may be combined with each other, and any combination is within the scope of protection of the present disclosure. In addition, although the functional module division is performed in the device schematic diagram, in some cases, it may be different from the module division in the device. Furthermore, the terms “first”, “second”, and the like as used herein do not limit the data and order of execution, but merely distinguish the same item or similar item having substantially the same function or action.

At present, for the alternating current charging pile, when charging an electric equipment, the thermal runaway phenomenon often occurs, which causes the electric equipment to catch fire and even causes the electric equipment to be burned and damaged. There are generally two cases of thermal runaway: the first case is that the internal resistance of the battery in the battery pack is larger when charging, resulting in that the heat generated by the battery with a larger internal resistance is larger when charging, and thermal runaway occurs; the second case is that the connection cable in the charging loop, or the connection terminal of the charging interface and the power reception interface, has a high impedance, which causes a large amount of heat to be generated where the resistance value in the connection cable is high, so that thermal runaway occurs.

In order to solve at least the above-mentioned problems, embodiments of the present disclosure provide a charging control method, a control device, a charging pile, and a charging system, where the charging control method is applied to the charging pile, enabling the charging pile to perform information interaction with a battery pack, to enable the charging pile to acquire charging parameters during charging of the battery pack, and to obtain a connection cable resistance value and an internal resistance of the battery according to the charging parameters, thereby performing safe charging control on the battery pack according to the connection cable resistance value and the internal resistance of the battery, and the charging safety risk is reduced.

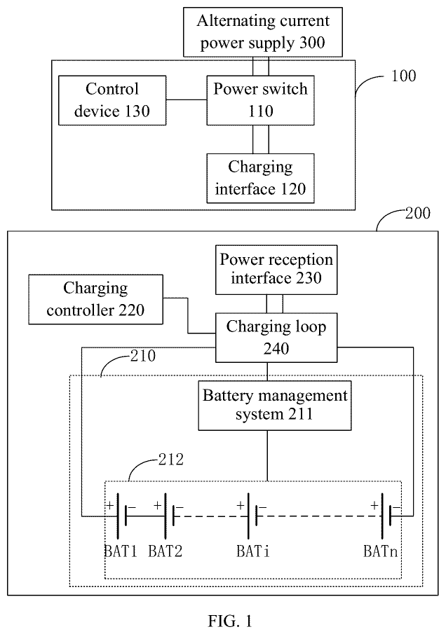

In a first aspect, embodiments of the present disclosure provide a charging system, referring to FIG. 1, the charging system includes a charging pile 100 and electric equipment 200.

The electric equipment 200 includes a battery pack 210 and a charging controller 220, where the battery pack 210 includes a battery management system 211 and n batteries (BAT1, BAT2, . . . , BATn). Each of the batteries (BAT1, BAT2, . . . , BATn) is successively connected in series; a battery management system 211 is respectively connected to each of the batteries (BAT1, BAT2, . . . , BATn); and the battery management system 211 is also communicatively connected to the charging pile 100, where n≥2, and n is an integer.

The electric equipment 200 is equipment that may include, but is not limited to, an electric vehicle, an unmanned aerial vehicle, and the like that use batteries as power. Each of the batteries (BAT1, BAT2, . . . , BATn) may include one cell or may include at least two cells connected in series and/or in parallel. Each of the batteries (BAT1, BAT2, . . . , BATn) are successively connected in series with each other to constitute a battery pack connected in series 212. In the following description, the first cell BAT1 refers to a cell at the head end of the battery pack connected in series 212, the i^{th} cell BATi refers to the i^{th} cell at the battery pack connected in series 212, and the n^{th} cell BATn refers to a cell at the tail end of the battery pack connected in series 212, where 0≤i≤n, and i is an integer.

The charging controller 220 is communicatively connected to the charging pile 100, the charging controller is also connected to each battery, and the charging controller is configured to control the charging current of each battery. The charging controller 220 may be a suitable microprocessor controller such as STM16, STM32, or the like. When the electric equipment 200 is an automobile, the charging controller 220 is an onboard controller.

In the charging system, the charging pile 100 is communicatively connected to the battery management system 211 and the charging controller 220, respectively; the charging pile 100 and the battery management system 211 may be connected via wired or wireless communication; and the charging pile 100 and the charging controller 220 may also be connected via wired or wireless communication. In this way, the charging pile 100 can perform information interaction with the battery pack 210, enabling the charging pile 100 to acquire charging parameters during charging of the battery, and to obtain a connection cable resistance value and an internal resistance of the battery according to the charging parameters, thereby performing safe charging control on the battery according to the connection cable resistance value and the internal resistance of the battery, and the charging safety risk is reduced.

In some embodiments, referring to FIG. 1, the electric equipment 200 further includes a power reception interface 230. An input end of the power reception interface 230 is used to connect the charging pile 100, and each of the batteries (BAT1, BAT2, . . . , BATn) is successively connected in series between two ends of the output end of the power reception interface 230. In an embodiment, a first end of the output end of the power reception interface 230 is connected to an anode of the first battery BAT1, and a second end of the output end of the power reception interface 230 is connected to a cathode of the n^{th} battery BATn. In an embodiment, the power reception interface 230 may be a charging gun slot, or a wireless power reception interface.

In some embodiments, referring to FIG. 1, the electric equipment 200 further includes a charging loop 240. The output end of the power reception interface 230, the charging loop 240 and the battery pack connected in series 212 are successively connected, the battery management system 211 is further connected to the charging loop 240, and the charging loop 230 is further connected to the charging controller 220. In an embodiment, two ends of an output end of the power reception interface 230 are correspondingly connected to a first input end and a second input end of the charging loop 240, respectively, a first output end of the charging loop 240 is connected to an anode of the first battery BAT1, and a second output end of the charging loop 240 is connected to a cathode of the n^{th} battery BATn. Thus, in the charging system, the charging controller 220 may control the charging loop 240 to control the magnitude of the charging current of the battery pack connected in series 212 according to the signal of the charging pile 100. The charging loop 240 may be used as an ACDC circuit, or a combination of an ACDC circuit and a DCDC circuit, and the specific arrangement thereof may refer to the prior art and is not limited thereto.

Embodiments of the present disclosure also provide a structure of a charging pile 100. Referring to FIG. 1, the charging pile 100 includes a power switch 110, a charging interface 120 and a control device 130.

A first end of the power switch 110 is used for connecting an alternating current power supply 300, a second end of the power switch 110 is used for connecting an input end of the charging interface 120, a third end of the power switch 110 is also connected to the control device 130, and an output end of the charging interface 120 is used for connecting the battery pack 210 in the electric equipment 200.

In an embodiment, when the battery pack 210 is connected to the charging pile 100, the batteries (BAT1, BAT2, . . . , BATn) are successively connected in series between two ends of the output end of the charging interface 120; the battery management system 211 is respectively connected to each of the batteries (BAT1, BAT2, . . . , BATn); and the control device 130 is respectively communicatively connected to the battery management system 211 and the charging controller 220. For example, an anode of the first battery BAT1 is connected to a first end of the output end of the charging interface 120, and a cathode of the n^{th} battery BATn is connected to a second end of the output end of the charging interface 120.

In an embodiment, referring to FIG. 1, when the electric equipment 200 includes a power reception interface 230 and a charging loop 240, and when the power reception interface 230 and the charging interface 120 establish a connection, an anode of the first battery BAT1 is connected to a first output of the charging loop 240, and a cathode of an n^{th} battery BATn is connected to a second output of charging loop 240. In this way, the control device 130 can cause the alternating current power supply 300 to charge each of the batteries (BAT1, BAT2, . . . , BATn) of the battery pack connected in series 212 or stop charging by controlling the power switch 110 to establish or disconnect a circuit formed by the alternating current power supply 300, the power switch 110, the charging interface 120, the power reception interface 230, and the battery pack connected in series 212.

In an embodiment, the control device 130 may be a general-purpose processor, a digital signal processor (DSP), an application specific integrated circuit (ASIC), a field programmable gate array (FPGA), a single chip microcomputer, an Acorn RISC Machine (ARM) or other programmable logic device, discrete gate or transistor logic, discrete hardware components, or any combination of these components.

In the charging pile 100, the control device 130 is used for executing the charging control method provided in the embodiment of the present disclosure, so that the charging pile 100 can perform information interaction with the battery pack 210, enabling the charging pile 100 to acquire charging parameters during charging of the battery pack connected in series 212, and to obtain a connection cable resistance value and an internal resistance of the battery according to the charging parameters, thereby performing safe charging control on the battery pack 210 according to the connection cable resistance value and the internal resistance of the battery, and the charging safety risk is reduced.

In some embodiments, the battery pack 210 also includes a current sampler disposed between the power reception interface 230 and the battery pack connected in series 212, and the current sampler is also connected to the battery management system 211. In an embodiment, the current sampler can be provided between a cathode of the n^{th} battery BATn and the second output end of the charging loop 240, and the current sampler is used for sampling the charging current of the battery pack connected in series 212 and sending sampled data to the battery management system 211, and the battery management system 211 can obtain the charging current of the battery pack connected in series 212 according to the sampled data and send the charging current to the control device 130. In practice, the current sampler may be used as a current transformer, or any suitable device known in the art that can be used to collect current and is not limited thereto.

In some embodiments, the battery pack 210 further includes a first voltage sampler, where the first voltage sampler is provided between the two ends of the output end of the power reception interface 230, and the first voltage sampler is also connected to the battery management system 211. The first voltage sampler is used for sampling the terminal voltage of charging loop, and sending the sampled data to the battery management system 211, where the battery management system 211 can obtain the terminal voltage of charging loop according to the sampled data, and send the terminal voltage of charging loop to the control device 130. In practice, the first voltage sampler may be used as any suitable voltage sampling device known in the art and is not limited thereto.

In some embodiments, the battery pack 210 further includes at least n second voltage samplers, each second voltage sampler being disposed between two ends of a battery, each second voltage sampler being further connected to the battery management system 211. The second voltage sampler is used for sampling the corresponding battery voltage and sending the sampled data to the battery management system 211, and the battery management system 211 can obtain each battery voltage according to the sampled data and send each battery voltage to the control device 130. In practice, the second voltage sampler may be used as any suitable voltage sampling device known in the art and is not limited thereto.

In some embodiments, after the charging pile 100 establishes a connection with the battery pack 210, the control device 130 is further configured to control the power switch 110 to close in response to a charging command to cause the alternating current power supply 300 to charge the battery pack 210 of the electric equipment 200.

In some embodiments, the power switch 110 includes a live wire switch and a neutral wire switch, where the live wire switch is connected between a first end of the input of the charging interface 120 and the live wire of the alternating current power supply 300, the neutral wire switch is connected between a second end of the input of the charging interface 120 and the neutral wire of the alternating current power supply 300, and the live wire switch and the neutral wire switch are respectively connected to the control device 130. Thus, when the control device 130 receives a charging command after the charging pile 100 establishes connection with the battery pack 210, the alternating current power supply 300 is caused to charge the battery pack 210 by controlling both the live wire switch and the neutral wire switch to be closed.

In some embodiments, the charging interface 120 may include a charging gun, or a wireless charging interface 120, etc.

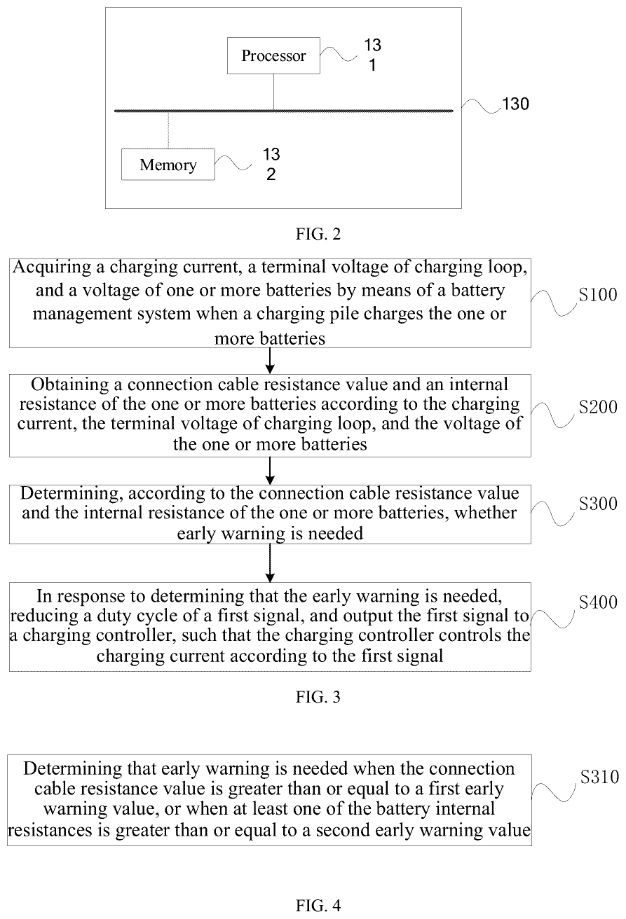

Embodiments of the present disclosure also provide a specific structure of a control device. Referring to FIG. 2, a hardware structure of the control device capable of performing the charging control method according to the embodiments of the present disclosure is shown. The control device may be a control device as shown in FIG. 1.

The control device includes: at least one processor 131; and a memory 132 communicatively connected to the at least one processor 131, one processor 131 being exemplified in FIG. 2. The memory 132 stores instructions executable by the at least one processor 131, the instructions are executed by the at least one processor 131 to enable the at least one processor 131 to perform the charging control method described below referring to FIGS. 3 and 4. The processors 131 and the memory 132 may be connected via a bus or in other ways, and via a bus connection exemplified in FIG. 2.

The memory 132 is a computer-readable storage medium that can be used to store a nonvolatile software program, a nonvolatile computer-executable program, and modules such as program instructions/modules corresponding to the charging control method in the embodiment of the present disclosure. The processor 131 executes various functional applications of the server and data processing by executing non-volatile software programs, instructions and modules stored in the memory 132, i.e., implements the charging control method described in the method embodiments described below.

The memory 132 may include a program storage area and a data storage area, where the program storage area may store an operating system and an application required by at least one function; the storage data area may store data or the like created according to the use of the charging pile. The memory 132 may include a high-speed random-access memory and may also include a non-volatile memory, such as at least one magnetic disk storage apparatus, flash memory apparatus, or other non-volatile solid state storage apparatuses. In some embodiments, the memory 132 may optionally include memory remotely located relative to the processor 131, which may be connected to the control device via a network. Embodiments of such networks include, but are not limited to, the Internet, Intranets, local area networks, mobile communication networks, and combinations thereof.

The one or more modules are stored in the memory 132 and, when executed by the one or more processors 131, perform the charging control method in any of the method embodiments described below, for example, performing the method steps of FIGS. 3 and 4 described below.

The above-mentioned product can execute the method provided by the embodiments of the present disclosure, and has corresponding functional modules and advantages for executing the method. Details not described can be found in the methods provided in the embodiments of the present disclosure.

A charging control method provided by an embodiment of the present disclosure is described below in detail referring to the accompanying drawings, where the charging control method can be performed by the control device in FIG. 1.

In a first aspect, an embodiment of the present disclosure provides a charging control method applied to the charging pile shown in any of the above embodiments. Referring to FIG. 3, the method includes:

Step S100: acquiring a charging current, a terminal voltage of charging loop, and a voltage of one or more batteries by means of a battery management system when a charging pile charges the one or more batteries.

Referring to FIG. 1, the charging current is a charging current flowing through the battery pack connected in series 212 when the alternating current power supply 300 charges the battery pack connected in series 212; the terminal voltage of charging loop is the voltage at both ends of the output end of the power reception interface 230. In an embodiment, the battery management system 211 acquires the charging current through the current sampler, acquires the terminal voltage of charging loop through the first voltage sampler, and acquires each battery voltage through each second voltage sampler, and transmits the charging current, the terminal voltage of charging loop, and each battery voltage to the control device 130.

It should be noted that when step S100 is performed, various parameters should be acquired by the battery management system 211 when charging is stable to ensure that the acquired charging parameters can accurately reflect the current charging state and improve the accuracy of charging control.

Step S200: obtaining a connection cable resistance value and an internal resistance of the one or more batteries according to the charging current, the terminal voltage of charging loop, and the voltage of the one or more batteries.

The connection cable resistance value is the sum of the resistance value of the first connection cable, the resistance value of the second connection cable, and the resistance value of the third connection cable. Referring to FIG. 1, the resistance value of the first connection cable is the connection cable resistance value between the first end of the output end of the power reception interface 230 and an anode of the first battery BAT1, the resistance value of the second connection cable is the connection cable resistance value between each of the batteries (BAT1, BAT2, . . . , BATn), and the resistance value of the third connection cable is the connection cable resistance value between a cathode of the n^{th} battery BATn and the second end of the output end of the power reception interface 230.

In an embodiment, the connection cable resistance value R and the internal resistance of each battery are obtained from the following formula:

$$U - {\sum }_{{n}_{1}} Ui = I ⋆ R ;$$

$$Ui = I ⋆ Ri ;$$

where I is the charging current, U is the terminal voltage of charging loop, Ui is the voltage of the i^{th} battery, and Ri is the battery internal resistance of the i^{th} battery, where 0≤i≤n, and i is an integer.

Step S300: determining, according to the connection cable resistance value and the internal resistance of the one or more batteries, whether early warning is needed.

After obtaining the connection cable resistance value and the internal resistance of each battery, if the connection cable resistance value is high, or at least one of the internal resistances of the batteries is high, a thermal runaway phenomenon is likely to occur, and then early warning is needed.

Step S400: in response to determining that early warning is needed, reduce a duty cycle of a first signal, and output the first signal to a charging controller, such that the charging controller controls the charging current according to the first signal.

In an embodiment, if the PMW protocol is used between the electric equipment 200 and the charging pile 100, then the first signal is a PWM signal. Under this protocol, the control device 130 is connected to the charging controller 220 via a cp terminal of the charging interface 120 and a cp terminal of the power reception interface 230, and the control device 130 can output a PWM signal to the charging controller 220, and the charging controller 220 can control the operation of the charging loop 240 according to the PWM signal to control the charging current of the battery pack connected in series 212.

The control device 130 outputs the PWM signal with a frequency of 1 kHz and a duty cycle of 10%-96%. When the allowable charging current of the charging pile 100 is 6-51 A, then the output PWM duty cycle=I/0.6, I being the charging current; the output PWM duty cycle=I/2.5+64 when the charging pile 100 allows a charging current of 51-80 A. It can be seen that the duty cycle of the PWM output by the charging pile has a certain relationship with the charging current. Then, when an early warning for thermal runaway is needed, the charging pile can adjust the charging current of the battery pack by adjusting the PWM signal, and reduce the charging current even to 0 to reduce the generation of a large amount of heat on the connection cable or battery with a high resistance value to avoid the occurrence of thermal runaway phenomenon and improve the charging safety.

It can be seen that in the charging control method provided in the embodiments of the present disclosure, information interaction can be performed between the charging pile and the battery pack, so that the charging pile acquires a charging parameter during charging of the battery pack, and obtains a connection cable resistance value and an internal resistance of the battery according to the charging parameter, thereby performing safe charging control on the battery pack according to the connection cable resistance value and the internal resistance of the battery to avoid a thermal runaway phenomenon, and the charging safety risk is reduced without increase in hardware cost, thus the costs are reduced.

In some embodiments, upon determining that early warning is needed, the method further includes stopping charging the battery. In an embodiment, referring to FIG. 1, when it is determined that early warning is needed, the control device 130 may directly control the power switch 110 to be opened to disconnect the alternating current power supply 300 and the battery pack connected in series 212 to stop the alternating current power supply 300 from charging the battery, and after the temperature decreases, the control device 130 may re-control the power switch 110 to be closed to enable the alternating current power supply 300 to re-charge the battery.

In some embodiments, referring to FIG. 4, the step S300 includes:
step S310: determine that early warning is needed when the connection cable resistance value is greater than or equal to a first early warning value, or when at least one of the battery internal resistances is greater than or equal to a second early warning value.

After obtaining the connection cable resistance value and the internal resistance of each battery, the connection cable resistance value can be compared with a first early warning value, and when the connection cable resistance value is greater than or equal to the first early warning value, it is indicated that the resistance at some point in the current charging loop is too high, and a large amount of heat is easily generated, and then early warning is needed. In addition, comparing the internal resistances of each battery with a second early warning value, and when at least one of the internal resistances of each battery is greater than or equal to the second early warning value, it is indicated that at least one of the internal resistances of the batteries in the current battery pack connected in series is too high, so that a large amount of heat is easily generated, and thus early warning is also needed.

In practical applications, the first early warning value and the second early warning value can be set according to actual needs and are not limited thereto. In general, the first early warning value may be a milli-ohm level of resistance value, the second early warning value may be a micro-ohm level of resistance value, and the sum of the first early warning value and the second early warning value may be a hundred milli-ohm level of resistance value. It will be appreciated that the first early warning value is related to the material of the connection cable and the second early warning value is related to the type of each battery.

In some of these embodiments, prior to step S100, the method further includes:
step S110: charging the battery pack in response to a charging instruction of a terminal.

Where the terminal can be a mobile terminal or a server, and when the connection between the battery pack and the charging pile is established, the user can send a charging instruction to the control device via the terminal, and after receiving the charging instruction, the control device controls the power switch to be closed so that the alternating current power supply charges the battery pack.

In a fifth aspect, embodiments of the present disclosure also provide a computer-readable storage medium having stored thereon computer-executable instructions that are executed by one or more processors, for example, to perform the method steps of FIGS. 3 and 4 described above.

In a sixth aspect, embodiments of the present disclosure also provide a computer program product including a computer program stored on a computer-readable storage medium, the computer program including program instructions which, when executed by a computer, cause the computer to perform a method in any of the method embodiments described above, for example, to perform the method steps of FIGS. 3 to 4 described above.

The embodiments of the present disclosure provide a charging control method, a control device, a charging pile, and a charging system, where the method is applied to a charging pile, the charging pile is used for connecting a battery pack, the battery pack includes a battery management system and at least n batteries, the battery management system is respectively connected to one or more batteries, the battery management system is also communicatively connected to the charging pile, and the batteries are connected in series, where n≥2, and n is an integer, and the method includes: when a charging pile charges one or more batteries, acquiring a charging current, a terminal voltage of charging loop, and a voltage of the one or more batteries by means of a battery management system; obtaining a connection cable resistance value and an internal resistance of the one or more batteries according to the charging current, the terminal voltage of charging loop, and the voltage of the one or more batteries; determining, according to the connection cable resistance value and the internal resistance of the one or more batteries, whether early warning is needed; and in response to determining that early warning is needed, reducing a duty cycle of a first signal, and outputting the first signal to a charging controller, such that the charging controller controls the charging current of the one or more batteries according to the first signal. By means of the method, the charging pile can perform information interaction with a battery pack, so that the charging pile performs safe charging control according to charging parameters, and the charging safety risk is reduced.

It should be noted that the embodiments of the apparatus described above are merely schematic, where the elements illustrated as separate components may or may not be physically separated, and the elements shown as elements may or may not be physical elements, i.e., may be in one place, or may also be distributed over a plurality of network elements. Some or all the modules may be selected according to actual needs to achieve the purpose of the solution of this embodiment.

From the above description of the embodiments, it will be clear to a person skilled in the art that the embodiments can be implemented by means of software plus a general-purpose hardware platform, but also by means of hardware. Based on the understanding, the above technical solutions substantially or otherwise contributing to the related art may be embodied in the form of a software product, which may be stored in a computer-readable storage medium, such as ROM/RAM, a magnetic disk, a compact disk, etc., and includes a plurality of instructions for executing the method according to each embodiment or some parts of the embodiments by at least one computer device (which may be a personal computer, a server, or a network device, etc.).

Finally, it should be noted that: the above-mentioned embodiments are merely illustrative of the technical solution of the present disclosure, and do not limit same; the technical features in the above embodiments or in different embodiments may also be combined under the idea of the present disclosure, the steps may be implemented in any order, and there are many other variations of the different aspects of the present disclosure as above, which are not provided in the details for the sake of brevity; although the present disclosure has been described in detail Referring to the foregoing embodiments, a person skilled in the art will appreciate that: the technical solutions disclosed in the above-mentioned embodiments can still be amended, or some of the technical features thereof can be replaced by equivalents; however, these modifications or substitutions do not bring the essence of the corresponding technical solutions out of the scope of the technical solutions of the various an embodiment of the present disclosure.

The above description is only a particular embodiment of the present disclosure, but the scope of protection of the present disclosure is not limited thereto, and various changes or substitutions will readily occur to a person skilled in the art within the scope of the present disclosure, and these are intended to be within the scope of protection of the present disclosure. Therefore, the scope of protection of the present disclosure should be determined by the scope of the claims.

What is claimed is:

1. A charging control method, comprising:
acquiring, by a charging pile, a charging current, a terminal voltage of charging loop, and a voltage of one or more batteries by means of a battery management system when the charging pile charges the one or more batteries, wherein the charging pile is configured to connect an electric equipment, the electric equipment comprising a battery pack and a charging controller, the battery pack comprising the battery management system and n batteries, the battery management system being connected to the one or more batteries and communicatively connected to the charging pile, and the batteries being connected in series, wherein n≥2, and n is an integer;
obtaining, by the charging pile, a connection cable resistance value and an internal resistance of the one or more batteries according to the charging current, the terminal voltage of charging loop, and the voltage of the one or more batteries;
determining, by the charging pile according to the connection cable resistance value and the internal resistance of the one or more batteries, whether early warning is needed; and
in response to determining that the early warning is needed, reducing, by the charging pile, a duty cycle of a first signal, and outputting, by the charging pile, the first signal to the charging controller, such that the charging controller controls the charging current according to the first signal.

2. The charging control method according to claim 1, wherein obtaining, by the charging pile, the connection cable resistance value and the internal resistance of the one or more batteries according to the charging current, the terminal voltage of charging loop, and the voltage of the one or more batteries comprises:
obtaining the connection cable resistance value R and the internal resistance of the one or more batteries from the following formula:
$$U - {\sum }_{{n}_{1}} Ui = I ⋆ R ;$$
$$Ui = I ⋆ Ri ;$$
wherein I is the charging current, U is the terminal voltage of charging loop, Ui is a voltage of an i^{th} battery, and Ri is a battery internal resistance of the i^{th} battery, wherein 0≤i≤n, and i is an integer.

3. The charging control method according to claim 2, wherein determining, by the charging pile according to the connection cable resistance value and the internal resistance of the one or more batteries, whether early warning is needed comprises:
in response to that the connection cable resistance value is greater than or equal to a first early warning value, or at least one battery internal resistance of the one or more batteries is greater than or equal to a second early warning value, determining that the early warning is needed.

4. The charging control method according to claim 1, further comprising:
before acquiring the charging current, the terminal voltage of charging loop, and the voltage of one or more batteries by means of the battery management system, charging, by the charging pile, the battery pack in response to a charging instruction of a terminal.

5. The charging control method according to claim 2, further comprising:
before acquiring the charging current, the terminal voltage of charging loop, and the voltage of one or more batteries by means of the battery management system, charging, by the charging pile, the battery pack in response to a charging instruction of a terminal.

6. The charging control method according to claim 3, further comprising:
before acquiring the charging current, the terminal voltage of charging loop, and the voltage of one or more batteries by means of the battery management system, charging, by the charging pile, the battery pack in response to a charging instruction of a terminal.

7. A control device, comprising:
at least one processor; and
a memory communicatively connected to the at least one processor; wherein
the memory stores an instruction executable by the at least one processor, and the instruction is executed by the at least one processor to cause the at least one processor to perform acts comprising:
acquiring a charging current, a terminal voltage of charging loop, and a voltage of one or more batteries by means of a battery management system when a charging pile charges the one or more batteries, wherein the charging pile is configured to connect an electric equipment, the electric equipment comprising a battery pack and a charging controller, the battery pack comprising the battery management system and n batteries, the battery management system being connected to the one or more batteries and communicatively connected to the charging pile, and the batteries being connected in series, wherein n≥2, and n is an integer;
obtaining a connection cable resistance value and an internal resistance of the one or more batteries according to the charging current, the terminal voltage of charging loop, and the voltage of the one or more batteries;
determining, according to the connection cable resistance value and the internal resistance of the one or more batteries, whether early warning is needed; and
in response to determining that the early warning is needed, reducing a duty cycle of a first signal, and outputting the first signal to the charging controller, such that the charging controller controls the charging current according to the first signal.

8. The control device according to claim 7, wherein obtaining a connection cable resistance value and an internal resistance of the one or more batteries according to the charging current, the terminal voltage of charging loop, and the voltage of the one or more batteries comprises:
obtaining the connection cable resistance value R and the internal resistance of the one or more batteries from the following formula:
$$U - {\sum }_{{n}_{1}} Ui = I ⋆ R ;$$
$$Ui = I ⋆ Ri ;$$
wherein I is the charging current, U is the terminal voltage of charging loop, Ui is the voltage of the i^{th} battery, and Ri is the battery internal resistance of the i^{th} battery, wherein 0≤i≤n, and i is an integer.

9. The control device according to claim 8, wherein the determining, according to the connection cable resistance value and the internal resistance of the one or more batteries, whether early warning is needed comprises:
determining that early warning is needed when the connection cable resistance value is greater than or equal to a first early warning value, or when at least one of the battery internal resistances is greater than or equal to a second early warning value.

10. The control device according to claim 7, wherein before the at least one processor performs the act of acquiring a charging current, a terminal voltage of charging loop, and a voltage of one or more batteries by means of a battery management system, the at least one processor performs act comprising:
charging the battery pack in response to a charging instruction of a terminal.

11. A charging pile, comprising
a power switch,
a charging interface, and
the control device according to claim 7; wherein
a first end of the power switch is configured to connect to an alternating current power supply, a second end of the power switch is configured to connect to an input end of the charging interface, a third end of the power switch is connected to the control device, and an output end of the charging interface is configured to connect to a battery pack.
